(19) United States
(12) Patent Application Publication
(10) Pub. No.: US 2026/0286166 A1
(43) Pub. Date: Sep. 24, 2026

(54) AQUEOUS COMPOSITIONS WITH MULTI-FUNCTIONAL, NITROGENOUS, ORGANIC ADDITIVE

(71) Applicant: SWIMC LLC, Cleveland, OH (US)

(72) Inventors: Tony A. Rook, Lakewood, OH (US); Katherine A. Miller, Cleveland, OH (US); Stacy L. Conte, Bath Township, OH (US); Kimberly Percival, Fairview Park, OH (US)

(21) Appl. No.: 19/474,331

(22) PCT Filed: Apr. 8, 2024
(86) PCT No.: PCT/US2024/023524

§ 371 Date: Oct. 10, 2025

Related U.S. Application Data
(60) Provisional application No. 63/495,794, filed on Apr. 13, 2023.

(51) Int. Cl. C09D 133/08; C08K 3/22; C08K 5/17; C08K 5/3432; C08K 5/47; C09D 7/61; C09D 7/63

(52) U.S. Cl. CPC C09D 133/08; C08K 3/22; C08K 5/17; C08K 5/3432; C08K 5/47; C09D 7/61; C09D 7/63; C08K 2003/2241

(57) ABSTRACT

Aqueous compositions such as polymeric binder compositions and coating compositions include a carrier liquid, film-forming polymeric binder, and a nitrogenous, organic additive including at least one compound having four nitrogen centers, each nitrogen center linked to at least one other nitrogen center by at least one hydrocarbon linking group. The coating compositions may show improved washability, scrub durability, and dispersion stability and lesser susceptibility to bacterial spoilage than conventional coating compositions that do not contain the nitrogenous, organic additive.

### FIELD OF THE INVENTION

This application relates to preservation of coating and coating compositions via additives that exhibit multi-functional effects including reduced susceptibility to microbial spoilage and improved or maintained paint or coating performance.

### BACKGROUND

Coating compositions such as paints typically contain four essential ingredients: carrier liquid, binder, pigment, and additives. Each of such ingredients may comprise a single component or several different items mixed into the paint.

The carrier liquid is a fluid component of the coating composition which serves to carry all of the other composition components. The carrier liquid is part of the wet coating composition and usually evaporates as the coating forms a film and dries on a surface. In latex paints, the carrier liquid is usually water. In oil-based or solvent-borne paints, the carrier liquid is usually an organic solvent. The amount and type of carrier liquid is usually determined by features of the other paint components.

The binder component of a coating composition allows the coating to form a film on and adhere to a substrate, and provides for durability of the cured coating, among other benefits. In a waterborne coating composition, the binder comprises a polymeric binder, usually selected from (meth)acrylics, vinyl acrylics, styrene acrylics, waterborne polyurethane dispersions (PUD), waterborne alkyd binders, waterborne alkyd-PUD hybrids, or combinations thereof. In the polymeric binder of a waterborne coating composition, the polymeric binder is usually provided as an aqueous latex, with latex particles in an emulsion or dispersion in water as the carrier liquid. In a solvent borne paint or coating, the binder or film forming agent comprises an acrylic-amino, alkyd, polyurethane, or epoxy resin.

Pigments provide the coating with both decorative and protective features, among other benefits. Pigments are dispersed solid particles used to provide the paint with various qualities, including but not limited to color, opacity, and durability. The coating may also include other organic or inorganic extenders, which can provide additional performance characteristics, including by modifying the surface appearance (e.g., gloss/flatness and sheen) of the coating.

Other additives may be included in paints and coating compositions. The additives are typically used at relatively low levels in the paint or coating composition compared to the binder, but contribute to various properties of paints and coating, including rheology, stability, paint performance, and application quality. Paints and coating compositions are complex formulations, and different additives can interact to have unpredictable, favorable, or unfavorable impacts on the various properties of the paint or coating. In formulating a paint or coating, the addition to or modification of a paint or coating formula with different additives or other components must be carefully balanced such that important properties of the paint or coating, such as washability, scrub resistance, heat and age stability, and microbial preservation, to name only a few, are maintained, improved, or subject to only minimal, tolerable decreases in quality.

Biocides, which are also referred to as antimicrobial agents, are additives which have microbistatic or microbicidal properties. In coating composition formulations, biocides may have a preservative effect to prevent in-can or wet-state microbial spoilage and ensure paint or coating composition stability, and may also provide dry-film or dry-state preservation, whereby a biocide in a dried paint or coating film prevents or mitigates growth of microbes, usually in the form of mildew or fungus, on the surface of the coating. Spoilage of a coating composition by microbial contamination or undesirable amount of in-container microbial growth can result in putrefaction, lowered pH, gas formation, and changes in viscosity that may make the coating composition unusable or have undesirable properties. As a result, paint and coating compositions must be adequately preserved to remain useful through manufacturing, distribution, and storage.

A variety of antimicrobial additives are well-known and are used for various purposes. Antimicrobial additives include organic biocides such as organic acids, phenols, alcohols, and quaternary ammonium compounds. Quaternary ammonium compounds, such as those disclosed in U.S. Pat. No. 9,131,683 B2, act as biocides by damaging cell membranes and killing bacteria. Organic antimicrobial additives further include conventional isothiazolinone additives including, but not limited to, benzisothiazolinone (“BIT”), methylisothiazolinone (“MIT”), and 2-methyl-4-isothiazolin-3-one (“CMIT”). Although effective biocides to preserve paint, isothiazolinones like BIT, MIT, and CMIT are increasingly at risk from supply chain/manufacturing risks including limited production sources, as well as potential emerging regulations. There are also inorganic antimicrobial additives, for example, those containing metal ions, such as silver-, zinc- (including zinc pyrithiones), and copper-based biocides. Other inorganic antimicrobial additives include phosphates, metal ion, metal, and biocide-containing zeolites or hydroxyapatites. These conventional antimicrobial additives may present similar supply chain or regulatory risks, and thus there is a need to find ways to adequately preserve paints and coatings using less or none of the conventional biocides.

### SUMMARY OF THE INVENTION

Disclosed are aqueous compositions including a carrier liquid, a film-forming polymeric binder, and a nitrogenous, organic additive including at least one compound comprising four nitrogen centers, each nitrogen center linked to at least one other nitrogen center by at least one saturated divalent hydrocarbon linking group. In some approaches, the aqueous composition is a latex emulsion or polymeric dispersion, paint, coating composition, caulk, or sealant. Optionally, the nitrogenous, organic additive is a post-addition component of the emulsion, dispersion, paint, coating composition, caulk, or sealant.

In some approaches, coating compositions of the present disclosure provides maintained or improved coating performance characteristics, like maintained or reduced susceptibility to microbial spoilage, maintained or improved washability, maintained or improved scrub resistance, and maintained or improved age or heat age stability relative to coating compositions that do not include the nitrogenous, organic additive. In some approaches, aqueous compositions of the present disclosure maintain acceptable resistance to microbial growth despite including reduced amounts of certain known antimicrobial additives.

The summary of the present disclosure is not intended to describe each disclosed embodiment or every implementation of the present disclosure. The description that follows more particularly exemplifies illustrative embodiments. In several places throughout the disclosure, guidance is provided through lists of examples, which examples may be used in various combinations. In each instance, any recited lists serve only as a representative group and should not be interpreted as an exclusive or exhaustive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter.

### Definitions

Unless otherwise specified, the following terms as used herein have the following meanings.

As used herein, the term “1K” or “one-component,” when used with reference to a coating composition, means the coating composition is applied to a substrate in only one part and can cure under ambient or bake conditions without the addition of a second part.

As used herein, the term “2K” or “two-component,” when used with reference to a coating composition means the coating composition is comprised of two parts that are kept separate until time of application. Typically 2K coating compositions are reactive, with one of said two parts serving to activate the other of the said two parts when the parts are combined to initiate curing or hardening of the 2K coating composition.

As used herein, the terms “adequate preservation” or “adequately preserved” when used with reference to a composition, mean that the composition passes the below-described, Microbial Challenge Test.

As used herein, the term “binder resin” refers to a polymeric resin that coalesces, cures, or otherwise assists film formation from a liquid or solid coating composition.

The term “component” refers to any compound that includes a particular feature or structure in a composition. Examples of components include compounds, monomers, oligomers, polymers, and organic groups contained there. A person of ordinary skill in the art will recognize that this definition of “component” is distinct from the term as used in the context of a “one-component” or “two-component” coating composition, as defined above.

The term “double bond” is non-limiting and refers to any type of double bond between any suitable atoms (e.g., C, O, N, etc.). The term “ethylenically unsaturated” refers to compounds that include a carbon-carbon double bond (i.e. —C═C—).

The term “film-forming” means that a composition includes sufficient amount of binder such that when applied to a surface and cured, the composition forims a continuous coating film.

The term “volatile organic compound” (“VOC”), as defined by the Environmental Protection Agency (EPA) in 40 C.F.R. 51.100(s), refers to any compound of carbon, excluding carbon monoxide, carbon dioxide, carbonic acid, metallic carbides or carbonates, and ammonium carbonate, which participates in atmospheric photochemical reactions except certain exempt compounds identified by the EPA. As used herein, “volatile organic compound content” (“VOC content”) in an aqueous composition such as a coating composition, aqueous polymeric binder composition, or other composition, means the weight of VOC per volume of the coating solids. VOC may be reported, for example, as grams VOC per liter (g/L). With respect to a latex polymer described herein, VOC may also be reported as grams VOC per 100 grams of latex polymer (with reference to grams of the solids in the latex). VOC content is measured by ASTM method D6886-18 with methyl palmitate as a marker.

As used herein, the term “glass transition temperature” or “Tg” refers to midpoint of the temperature range in which an amorphous, solid material undergoes a reversible transition from a glass-like state to a rubber-like state. “Glass transition temperature” or Tg may be predicted using the Fox equation or measured by Differential Scanning Calorimetry. Unless otherwise indicated, the Tg values described herein are theoretical values predicted using the Fox equation. Application of the Fox equation to estimate the Tg of polymers is well known in the art. Tg may be measured using Differential Scanning Calorimetry. Samples of composition for differential scanning calorimetry (“DSC”) testing are weighed into standard sample pans, and analyzed using a standard DSC heat-cool-heat method. A sample is heated at 10° C. per minute from 50° C. to 150° C., then cooled to −75° C. at 20° C./min, then stabilized at −75° C. before reheating to 150° C. at 10° C./min. Glass transition temperatures are calculated from the thermogram of the last heat cycle. The glass transition is measured at the inflection point of the transition.

Sheen may also sometimes be referred to as gloss. In a coating, a gloss finish indicates that the surface which has a coating applied to it (i.e., is finished) is shiny or glass-like. The gloss of a surface is described as the reflection of light from the surface that is independent of color. ASTM D523 may be used to measure gloss or sheen. The prescribed angle at which light is reflected off the surface may vary, but for the purposes of this disclosure, 85 Sheen is measured at 850 relative to the surface reflecting the light. ASTM D523 may also be used to evaluate 60 Gloss, which is measured at 60° relative to the surface reflecting the light. Gloss may also refer to the gloss intensity measured at 20, 60, or 85 degrees and is determined according to ASTM D523. One of skill in the art is able to determine relative levels of gloss (low versus high) in context of each coating.

The term “substantially free of VOC” means that the composition contains less than about 50 g/L VOC. Unless otherwise indicated, the terms “low VOC” and “substantially free of VOC” are used interchangeably herein. The term “essentially free of VOC” means that the composition contains less than 5 g/L of VOCs. The terms, “zero VOC” and “essentially free of VOC” are used interchangeably herein.

The term “substantially free,” when applied to components of a composition and not to VOC content, means that the composition contains no more than about 1 wt. % of a particular component, based on total weight of solids in the composition. For example, a composition that is substantially free of conventional biocide contains no more than about 1 wt. % conventional biocide as a percentage of the solids weight of the composition. A composition that is “essentially free” when applied to components of a composition and not to VOC levels, means the composition contains no more than about 0.04 wt. % of the material. A composition that is “completely free” when applied to components of a composition and not to VOC levels, means the composition contains no more than trace amounts of the material on a percentage solids of the composition basis.

As used herein, the term “container” means any vessel (either with or without a lid or other type of closure) used to store, mix, tint or color a paint formulation, and includes the vessels in which paints and coatings are typically marketed and sold. Suitable containers include paint cans, paint bottles, containers made of metal, containers made of plastic and/or other polymeric materials, and the like.

The term “scrub resistance,” as used herein, refers to the ability of the surface of a coating film or paint film to resist being worn away or to maintain its original appearance when rubbed with or against an abrasive surface, typically during cleaning. Scrub resistance is measured according to ASTM D2486-96 (Standard Test Method for Scrub Resistance of Wall Paints). As reported according to the standard test method, a larger number of scrubs indicates greater scrub resistance.

The term “pigment” includes both colored, dispersible solid particulate materials and colored dispersible or soluble dye materials, wherein the material imparts visually noticeable color to a paint or coating when 5 wt. % (in the case of a colored, dispersible solid particulate) or 0.05 wt. % (in the case of a colored, dispersible or soluble dye) of the material is added to (e.g., dispensed into) the paint or coating. The presence or absence of visually noticeable color may be assessed by preparing drawdown samples of the paint or coating with and without the pigment, casting such samples as 25 micrometer (μm) dry thickness coated films over the white part of a BYK-Gardner No. PA-2811 opacity drawdown chart (from BYK-Gardner USA) or comparable chart, and examining the coated films under normal overhead interior illumination. Pigments may also impart opacity to a coating without significant effect on color.

The term “pigment volume concentration” (PVC) when used in respect to a paint, stain or colorant means the total percentage of dried coating volume occupied by all inorganic species in the coating. The PVC of a coating composition is the ratio of the volume of pigments (including fillers and functional fillers) to the volume of total non-volatile material (i.e. binder solids) present in the coating.

The term “post-addition component” or “post-add” refers to a component of a coating composition or aqueous polymeric binder composition that can be added at any stage during the blending of a coating composition or polymeric binder composition prior to application or curing of the composition, but after polymerization of the polymeric binder from monomers.

Unless otherwise indicated, a reference to a “(meth)acrylate” compound (where “meth” is bracketed) is meant to include both acrylate and methacrylate compounds. For instance, the term “(meth)acrylate polymer” includes independently, each of acrylate homopolymers, methacrylate homopolymers, and copolymers that include interpolymerized acrylate and methacrylate monomers.

The term “multistage,” as used herein with respect to a latex means the latex polymer was made using discrete, sequential charges of two or more monomers or monomer mixtures, or was made using a continuously-varied charge of two or more monomers. A multistage polymer is distinct from a single stage polymer made using one type of monomer blended with distinct polymer seed particles.

The terms “waterborne” or “water-based” refer to compositions that include a carrier that is more than 50% by weight water as a percentage of the total carrier weight.

The term “on”, when used in the context of a coating applied on a surface or substrate, includes both coatings applied directly to the surface or substrate or indirectly such that an intermediate layer is present between the coating and the surface or substrate. Thus, for example, a coating applied to a primer layer overlying a substrate constitutes a coating applied on the substrate.

Unless otherwise indicated, the term “polymer” includes both homopolymers and copolymers (i.e., polymers of two or more different monomers).

The term “coating composition” encompasses paints and also aerosol coatings, caulks, stains, and sealants. Coating compositions may be suitable for use on the interior or exterior of building or construction surfaces, e.g., walls, trim, floor, decks, wood or metal railings, ceilings, roofs (including metal roofing, shingles and tiles), roadways, sidewalks, etc.

The term “paint” means a coating composition including pigment and binder which when applied to form a thin (e.g., 100 μm) wet thickness coating film on a freshly-sanded smooth wood surface, will when dried hide both the wood grain and its texture and will present a new surface with its own appearance.

The term “comprises” and variations thereof do not have a limiting meaning where these terms appear in the description and claims.

The terms “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention or claims.

As used herein, “a,” “an,” “the,” “at least one,” and “one or more” are used interchangeably. Thus, for example, a coating composition that comprises “an” additive can be interpreted to mean that the coating composition includes “one or more” additives.

Also herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 1 to 2, etc.).

Reference throughout this specification to “aspects,” “an aspect,” “some aspects,” “approaches,” “an approach,” some approaches,” “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearance of these phrases in various places throughout this specification are not necessarily referring to the same embodiment of the disclosure, even though in both instances the same term (e.g., “aspect” or “approach”) is present. Furthermore, the particular features, configurations, compositions, or characteristics may be combined in any suitable manner in one or more embodiments.

### DETAILED DESCRIPTION

The present disclosure provides for aqueous compositions that include a nitrogenous, organic additive as further defined herein as well as method of preserving aqueous compositions by adding one or more nitrogenous, organic additives. It has been found that such compositions exhibit reduced susceptibility to microbial spoilage in the liquid state. In some embodiments, the compositions may provide improved or maintained coating performance characteristics, including but not limited to improved or maintained physical durability as indicated by scrub testing, improved or maintained washability, and improved or maintained dispersion stability, as shown by heat age stability or age stability, as compared to a coating not containing the nitrogenous, organic additive. These characteristics are surprisingly found without the need for or with a reduced need for the use of conventional biocides like isothiazolinones, pyrithiones, inorganic biocides, or other biocides. As detailed further herein, such aqueous compositions may be a coating composition such as a paint, caulk, or sealant, or an aqueous latex or aqueous dispersion or emulsion of a polymeric binder.

The present disclosure comprises, in some approaches, a coating composition comprising water, a film-forming polymeric binder, pigment, and additives, wherein such additives include, but are not limited to, the nitrogenous, organic additive. In some embodiments, the coating composition includes minimal or no pigment and is considered a “clear coat” coating. In some embodiments, the coating compositions are substantially, essentially, or completely free of conventional biocides.

In some approaches, the present disclosure comprises an aqueous polymeric binder composition comprising water, polymeric binder, and the nitrogenous, organic additive. In some embodiments, the aqueous polymeric binder composition is substantially, essentially, or completely free of conventional biocides.

In another approaches, the present disclosure provides a coated article, whereby the article is coated with the nitrogenous, organic additive additive-containing coating compositions disclosed herein, the coating composition cured on a substrate. In certain approaches, said coatings compositions are formulated for coating the outside or inside surfaces of an architectural structure. In other embodiments, the coatings compositions are formulated for coating the inside of a beverage can, for covering a steel coil, for coating a plastic, for lining an industrial tank (e.g., water tanks, chemical bulk tanks, etc.), or for protective and marine applications. In some approaches, coating compositions of the present disclosure may be used to coat wood, plastic, drywall, concrete, metal, rubber or other natural or synthetic polymers. In some approaches, compositions of the present disclosure may be employed with an undercoat or an overcoat. Other coatings applications are considered within the scope of the present invention and disclosure, even if not expressly disclosed herein.

### Aqueous Compositions

Aqueous compositions of the present disclosure include but are not limited to paints, adhesives, sealants, stains, caulks, and mineral and pigment slurries, as well as waterborne emulsions and waterborne dispersions of polymeric binders and resins.

### Nitrogenous, Organic Additives

The nitrogenous, organic additives in compositions of the present disclosure allow the formulation of coatings compositions and aqueous polymeric binder compositions that are adequately preserved or have reduced susceptibility to microbial spoilage. Such compositions provide other improved or maintained coatings performance characteristics including but not limited to scrub durability, washability, and heat age stability or age stability. In some embodiments, coatings compositions and aqueous polymeric binder compositions of the present disclosure may be provided without the need for or with a reduced need for the use of conventional biocides like isothiazolinones, pyrithiones, inorganic, or other biocides.

The nitrogenous, organic additives useful in the present disclosure include compounds or mixtures of compounds that each include four nitrogen centers, with each nitrogen center linked to at least one other nitrogen center by a at least one hydrocarbon linking group. In exemplary embodiments, the hydrocarbon linking groups are each saturated and divalent. In exemplary embodiments, the hydrocarbon linking groups are each, independently a linear or branched C1, C2, C3, or C4 chain.

In further exemplary embodiments, the nitrogenous, organic additives are selected from the group consisting of compounds having the Formulas I, II, III, and IV, and mixtures thereof:

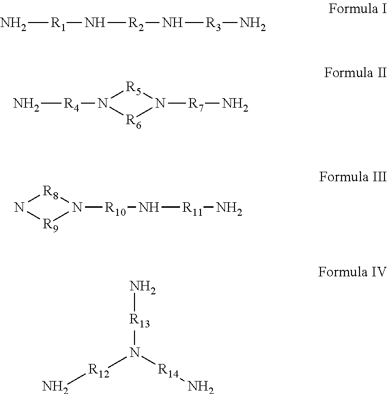

In some approaches, each of R1-R4, R7, and R10-R14 is a saturated, divalent hydrocarbon chain having 1 to 3 carbons, each of R5, R6, R8, and R9 is a saturated, divalent hydrocarbon chain having 2 to 3 carbons, and each of R1-R14 is the same or different. In some embodiments, each of R1-R4, R7, and R10-R14 is a saturated hydrocarbon chain having 1 to 2 carbons, each of R5, R6, R8, and R9 is a saturated hydrocarbon chain having 2 to 3 carbons, and each of R1-R14 is the same or different.

In some embodiments, suitable nitrogenous, organic additives include compounds selected from the group consisting of amino acid hydrazides, hydrazides of carbazido-carboxylic acids, bis-hydrazides and bis-carbazides, diethylene triamine, N,N′-bis(2-aminoethyl)-1,2-ethanediamine, tetraethylene pentamine, pentaethylene hexamine, tris-(2-aminoethyl)amine, N-(2-piperazinoethyl)-ethylene diamine, N,N′-bis-(2-aminoethyl)-piperazine, N,N,N′-tris-(2-aminoethyl)ethylene diamine, N-(2-aminoethyl)-N′-(2-piperazinoethyl-1)-ethylene diamine, N,N-bis-(2-aminoethyl)-N-(2-piperazinoethyl)amine, N,N-bis-(2-piperazinoethyl)-amine, polyethylene imine oligomers comprising at least four functional monomer units, N-(2-aminoethyl)-1,3-propane diamine, polyoxypropylene amine oligomers comprising at least four functional monomer units monomers, tetrapropylene pentamine, tripropylenetetramine, and N,N′-bis-(3-aminopropyl) ethylene diamine, and mixtures thereof.

In some approaches, the nitrogenous, organic additives do not include any aryl functional groups in their chemical structure.

In some preferred approaches, suitable nitrogenous, organic additives include compounds selected from the group consisting of N,N′-bis(2-aminoethyl)-1,2-ethanediamine, N,N′-bis-(2-aminoethyl)piperazine, N[(2-aminoethyl)2-aminoethyl]piperazine, tris-(2-aminoethyl)amine), or a mixture thereof.

In some further preferred approaches, the suitable nitrogenous, organic additive is a mixture called triethylenetetramine or TETA™ (available from the Dow Chemical Company, Midland, MI). TETA™ is a mixture of four nitrogenous, organic compounds each having four nitrogen centers, with each nitrogen center linked to at least one other nitrogen center by a at least one saturated divalent hydrocarbon linking group. The four nitrogenous, organic compounds in TETA™ consist of N,N′-bis(2-aminoethyl)-1,2-ethanediamine, N,N′-bis-(2-aminoethyl)piperazine, N[(2-aminoethyl)2-aminoethyl]piperazine, and tris-(2-aminoethyl)amine). In some approaches, TETA™ may further include about 5 wt. % to about 50 wt. % of a carrier as a percentage of the weight of the nitrogenous, organic additive, in further embodiments about 50 wt. % to about 30 wt. % carrier and in still further embodiments, about 20 wt. %. In some preferred approaches, the carrier is water, but may be acetone or methanol or other suitable carriers.

In some approaches, the aqueous composition includes at least 50 ppm of the nitrogenous, organic additive (based on weight of total components of the compositions). In some approaches, the aqueous composition includes at least 60 ppm of the nitrogenous, organic additive, in further embodiments at least 75 ppm of the nitrogenous, organic additive, in further embodiments at least 125 ppm of the nitrogenous, organic additive, in further embodiments at least 250 ppm of the nitrogenous, organic additive, in further embodiments at least 400 ppm of the nitrogenous, organic additive, in further embodiments at least 1500 ppm of the nitrogenous, organic additive and in still further embodiments, at least 5000 ppm of the nitrogenous, organic additive.

In some useful approaches, the aqueous composition includes at most 200,000 ppm of the nitrogenous, organic additive (based on weight of total components of the composition). In further embodiments, the aqueous composition includes at most 100,000 ppm of the nitrogenous, organic additive, in further embodiments at most 75,000 ppm of the nitrogenous, organic additive, in further embodiments at most 50,000 ppm of the nitrogenous, organic additive, in further embodiments at most 30,000 ppm of the nitrogenous, organic additive, in further embodiments at most 20,000 ppm of the nitrogenous, organic additive, and in still further embodiments, at most 10,000 ppm of the nitrogenous, organic additive.

The nitrogenous, organic additives useful in the present disclosure allow the formulation of aqueous compositions that are adequately preserved or have reduced susceptibility to microbial spoilage and other improved or maintained coatings performance characteristics, including but not limited to scrub durability, washability, and heat age stability or age stability. In embodiments, said coatings compositions may be provided without the need for or with a reduced need for the use of conventional biocides like isothiazolinones, pyrithiones, or inorganic or other materials.

### Carrier Liquid

Compositions of the present disclosure comprise a carrier liquid prior to application to a substrate. The carrier liquid may be water, include water, or be water-based (>50 wt. % water in the carrier liquid system). The carrier liquid may further include a solvent selected from aliphatic, cycloaliphatic and aromatic hydrocarbons such as white spirit, cyclohexane, toluene, xylene and naptha solvent, esters such as methoxypropyl acetate, n-butyl acetate and 2-ethoxyethyl acetate; octamethyltrisiloxane, or other solvents used in solvent borne systems and mixtures thereof. Carrier liquids may also be other liquids used in paints, adhesives, sealants, stains, caulks, and mineral and pigment slurries. Compositions of the present disclosure may include one or more carrier liquids. In some approaches, the carrier liquid or liquids are selected so as to provide an aqueous composition that is substantially free of VOC, essentially free of VOC, free of VOC, or zero VOC.

In a preferred embodiment of this disclosure, the carrier liquid of a coatings composition is water or is water-based or waterborne (>50 wt. % water in the carrier liquid system).

In some embodiments, carrier liquids may constitute 5-60% by volume of a coating composition. In some embodiments, carrier liquids may constitute 40-60% of an aqueous polymeric binder composition.

### Polymeric Binders

Aqueous compositions in accordance with the present disclosure also comprise a film-forming polymeric binder.

Film-forming polymeric binders useful in coating compositions are known in the art and include waterborne polymeric binders, such as acrylics, vinyl acrylics, styrene acrylics, waterborne polyurethane dispersions (PUD), waterborne alkyd binder resins, waterborne alkyd-PUD hybrid resins, and mixtures thereof. The polymeric binder is present in the aqueous composition in sufficient amount to form a continuous film when the aqueous composition is applied to a substrate and allowed to cure. In some embodiments, the aqueous composition may comprise for example, at least about 17% by weight, to about 60% by weight of polymeric solids based on the total weight of components of the aqueous composition.

In some embodiments, the polymeric binder is completely free or essentially free of any functional monomer units comprising reactive ketone moieties that cross-link the polymeric binder during film formation. In some embodiments, such reactive ketone moieties include diacetone acrylamide (“DAAM”) and acetoacetoxyethylmethacrylate (AAEM).

In certain preferred embodiments, the polymeric binder is a latex polymer. Latex polymers of the present invention may comprise a single stage or multistage latex polymer. In some embodiments, aqueous compositions of the present disclosure include a latex polymer that is a multistage latex polymer having at least a first stage and a second stage or a single stage latex polymer.

A multistage latex does not necessarily exhibit two glass transition temperatures as measured by differential scanning calorimetry (DSC). For example, a DSC curve for a multistage latex made using discrete charges of two or more monomers may exhibit two or more Tgs but may exhibit only one Tg. In cases where a DSC curve shows only a single Tg inflection point, or even no Tg inflection points, it may be difficult to determine whether the latex is single stage or multistage, as the observation of a Tg inflection point depends on various factors, including the relative concentration of monomers in a particular stage. Thus, the presence or absence of Tg inflection points on a DSC curve is not dispositive as to whether a particular latex polymer is single stage or multisgage, but the Tgs of a multistage latex may be described in terms of the theoretical Tg values for each monomer stage, as determined by the Fox equation.

Various methods can be used to prepare the multistage latex described herein, including for example, sequential monomer feed and continuously varying monomer feed techniques. In a sequential monomer feed process, a first monomer or monomer mixture is fed and polymerization initiated, and a second monomer (i.e. a different monomer, or a mixture of monomers present in different ratios than in the first monomer mixture) is fed during later stages of polymerization. In a varying monomer feed process, a first monomer composition is fed, followed by the addition of a second monomer at certain points in the polymerization process, and at different speeds. By controlling the type of monomers selected for the feed process, a multistage latex suitable for low VOC coating compositions or paints may be formed, and the latex preferably provides excellent performance characteristics, such as, for example, block resistance, scrub resistance, and the like, for such coating or paint formulations.

Preferred multistage latexes include at least two stages (e.g., two, three, or four or more stages) with different Tg values (not considering any Tg that may be associated with an optional “seed”). In some embodiments, each of the at least two stages constitute at least 15 weight percent (“wt %”), at least 20 wt %, at least 25 wt %, at least 30 wt %, at least 35 wt %, or at least 40 wt % of the multi-stage latex, based on the total weight of monomers used to make the latex (not including the weight of any optional seed used).

In some approaches, the multistage latex described herein is made by a sequential monomer feed process. In an aspect, polymerization begins with a higher Tg monomer feed followed by a lower Tg monomer feed, and vice-versa. In a preferred aspect, polymerization begins with a higher Tg monomer feed, followed by a lower Tg monomer feed.

In some approaches, the multistage latex described herein is made using varying monomer feeds. The resulting polymer will typically have a DSC curve that exhibits no Tg inflection points, and could be said to have an essentially infinite number of Tg stages. The resultant multistage latex will have a gradient Tg from high to low, or vice-versa, depending on the order that monomers of high Tg are fed into the reaction.

In a preferred approach, the multistage latex described herein is made by a sequential monomer feed process using at least two distinct feeds of monomers. In an aspect, a “high” Tg stage (i.e., a hard stage) is fed first into a reactor vessel, and a “low” Tg stage (i.e. a soft stage) is added at a later stage in the process. A multistage latex may be formed, and after coalescence, the composition will typically display two distinct Tg values, or at least one Tg corresponding to the monomer stage present at higher concentration. In some instances, no distinct Tg may be observed or detected by DSC for a monomer or monomer mixture in a particular stage that is present in very small quantities relative to the other monomer or monomer mixture.

In an approach, the multistage latex optionally includes a “seed” phase, i.e., a relatively small monomer or polymer particle, but the seed is not required, nor essential for preparation or optimal performance of the multistage latex when used in a coating composition or paint formulation.

In an approach, the relative positions of the first and second phases may be internal and external respectively, or vice-versa. In another aspect, the first and second phases may be neighboring or adjacent. Without being bound by theory, it is believed that the relative position of the stages of the multistage latex is influenced by the method used to make the latex.

In an approach, by controlling the monomers used for each stage of the sequential monomer feed process, a multistage latex with a desired minimum film forming temperature (MFFT) is obtained. The MFFT is the minimum temperature at which the composition comprising a multistage latex will form a continuous film, i.e. the temperature below which coalescence does not occur. The MFFT of the composition comprising a multistage latex as described herein is preferably less than about 30° C., more preferably less than about 20° C.

In some approaches, the latex polymer is a single stage latex, derived by polymerization in a single stage process of an emulsion including one or more ethylenically unsaturated monomers. By controlling the type of monomers used in the emulsion polymerization, a single stage latex suitable for low VOC coating compositions or paints may be formed.

In some approaches, by controlling the monomers used in the single stage latex synthesis, a single stage latex composition with desired MFFT is obtained. The MFFT of the single stage film-forming binder as described herein is preferably less than about 30° C., more preferably less than about 20° C.

Monomers interpolymerized into the single stage latex or stages of the multistage latex separately and preferably include one or more ethylenically unsaturated monomers.

In some approaches, the single stage latex monomers or the first and second stage of the multistage latex separately and preferably includes the one or more polymerization product(s) of (i) ethylenically unsaturated monomers, such as, for example, alkyl and alkoxy (meth)acrylates, vinyl esters of saturated carboxylic acids, monoolefins, conjugated dienes, optionally with (ii) one or more monomers, such as, for example, styrene, methyl methacrylate, butyl acrylate, 2-ethylhexyl acrylate, vinyl acetate, acrylonitrile, vinyl chloride, and the like. In an embodiment, the monomers of the latex polymers optionally include one or more polyfunctional (meth)acrylate monomers. In an embodiment, the monomers also include one or more ethylenically unsaturated carboxy-functional amide monomers, e.g., ureido-functional monomers, such as monomers formed as the product of the reaction between aminoalkyl alkylene urea (e.g., amino ethylene urea, for example) with an ethylenically unsaturated carboxylic acid or anhydride (e.g., maleic anhydride, for example).

Suitable ethylenically unsaturated monomers of the single stage latex or the stages of the multistage latex include, for example, acrylic acid, methacrylic acid, methyl acrylate, ethyl acrylate, propyl acrylate, butyl acrylate, 2-ethylhexyl acrylate, methyl methacrylate, ethyl methacrylate, propyl methacrylate, butyl methacrylate, 2-ethylhexyl methacrylate, hydroxyethyl acrylate, hydroxyethyl methacrylate, hydroxybutyl acrylate, hydroxybutyl methacrylate, glycidyl methacrylate, 4-hydroxybutyl acrylate glycidyl ether, or a dialkyl itaconate such as dimethyl itaconate, diethyl itaconate, dipropyl itaconate, or dibutyl itaconate, 2-(acetoacetoxy)ethyl methacrylate (AAEM), diacetone acrylamide (DAAM), acrylamide, methacrylamide, methylol (meth)acrylamide, styrene, α-methyl styrene, vinyl toluene, vinyl acetate, vinyl propionate, allyl methacrylate, and mixtures thereof. Preferred monomers include styrene, methyl acrylate, methyl methacrylate, ethyl acrylate, methacrylic acid, DAAM, AAEM, n-butyl acrylate, tert-butyl acrylate, tert-butyl methacrylate, n-butyl methacrylate, esters of itaconic acid, vinyl acetate, 2-ethyl hexyl acrylate, bio-renewable monomers, and the like.

In some approaches, the latex polymer is completely free or essentially free of any functional monomer units comprising reactive ketone moieties that cross-link the latex polymer during film formation. In some embodiments, such reactive ketone moieties include diacetone acrylamide (DAAM) or 2-(acetoacetoxy)ethyl methacrylate (AAEM).

Suitable polyfunctional (meth)acrylate monomers such as, for example, di-, tri- and tetra-functional acrylates such as dipropylene glycol diacrylate (DPGDA), propoxylated glyceryl triacrylate (GPTA), pentaerythritol tetraacrylate, dipentaerythritol tetraacrylate, mixtures thereof, and the like. Preferred polyfunctional acrylate monomers include pentaerythritol tetraacrylate, dipentaerytrithol tetraacrylate, and the like.

In some approaches, the latex polymer is formed of at least 80 wt % of two or more monomers selected from methyl methacrylate, ethyl acrylate, vinyl acetate, tert-butyl methacrylate, n-butyl methacrylate, styrene, tert-butyl acrylate, n-butyl acrylate, 2-ethyl hexyl acrylate, methyl acrylate, and esters of itaconic acid, based on the total weight of monomers used to form the latex copolymers (and not factoring any optional seed used).

In some approaches, the latex polymer is formed of at least 90 wt % of three or more monomers selected from methyl methacrylate, ethyl acrylate, vinyl acetate, tert-butyl methacrylate, n-butyl methacrylate, styrene, tert-butyl acrylate, n-butyl acrylate, 2-ethyl hexyl acrylate, methyl acrylate, and esters of itaconic acid, based on the total weight of monomers used to form the latex polymers (and not factoring any optional seed used).

Suitable ureido-functional monomers include, for example, monomers with the —NR—(C═O)—NH— functionality, where R may be H, substituted or unsubstituted C1-C10 alkyl, substituted or unsubstituted C3-C6 cycloalkyl or heteroalkyl, and the like. Without being bound by theory, ureido-functional monomers are believed to promote the wet adhesion of the coating compositions and coating and colorant systems described herein to a substrate.

In certain approaches, latex copolymers (whether single stage, multistage, or gradient Tg) are typically made using seed particles as a nucleating agent for polymerization. Such seed particles may be in the form of inorganic particulate seed (e.g., clay or glass particles), preformed particulate polymer seed (latex or non-latex polymer seed), or particulate seed polymer formed in situ. Polymer seed can be an emulsion polymerized polymer seed, but does not encompass polymeric surfactant. In certain embodiments, seed particles are used in an amount of no more than 10 wt %, or no more than 5 wt %, based on latex polymer solids in the final latex.

Herein, whether inorganic particulate seed, preformed particulate polymer seed, or particulate seed polymer formed in situ, such seed particles will not be deemed to provide a stage of a multistage polymer or to provide a basis for designating a single stage polymer or gradient Tg polymer made using such seed polymer as a multistage polymer.

In certain approaches, the latex copolymers of the present invention may further include crosslinking monomers having the ability to further react with a polymer chain at some time after initial formation of the latex copolymer (e.g., during coating cure). The crosslinking reaction can occur through the application of energy, e.g., through heat or radiation. Or, dying can activate the crosslinking polymer through changes in pH, oxygen content, evaporation of solvent or carrier, or other changes that causes a reaction to occur. A variety of chemistries are known in the art to produce crosslinking in latexes. When used, such one or more crosslinking monomers are typically are included in the latex copolymer in an amount of at least about 0.1 wt %, at least about 1.0 wt %, at least about 2 wt %, at least about 2.5 wt %, at least about 3 wt %, at least about 4 wt %, or at least about 5 wt %, based on the weight of the one or more crosslinking monomers relative to the total weight of monomers used to form the latex copolymer. While the amount of such one or more crosslinking monomers may vary widely, typically the one or more crosslinking monomers are present in the latex copolymer in an amount of about 10 wt % or less, about 9 wt % or less, about 8 wt % or less, about 7 wt % or less, about 6 wt % or less, or about 5 wt % or less, based on the weight of the one or more crosslinking monomers relative to the total weight of monomers used to form the latex copolymer.

Suitable examples of crosslinking carbonyl-containing monomers include acrolein, methacrolein, diacetone acrylamide, diacetone methacrylamide, 2-butanone methacrylate, formyl styrol, diacetone acrylate, diacetone methacrylate, acetonitrile acrylate, acetoacetoxyethyl methacrylate, acetoacetoxyethyl acrylate and vinylacetoacetate. These monomers normally do not affect crosslinking until during final film formation, for example, when the aqueous polymer emulsion simultaneously contains an appropriate added amount of a polyamine compound as crosslinker. Particularly suitable compounds of this type are the dihydrazides and trihydrazides of aliphatic and aromatic dicarboxylic acids of 2 to 20 carbon atoms. Polyamine compounds useful as crosslinkers for the carboxyl functional groups include those having an average of at least two carbonyl-reactive groups of the formula —NH2 and carbonyl reactive groups derived from such groups. Examples of useful amine functional groups include R—NH2, R—O—NH2, R—O—N═C<, R—NH—C(═O)—O—NH2, wherein R is alkylene, alicyclic or aryl and may be substituted. Representative useful polyamines include ethylene diamine, isophorone diamine, diethylenetriamine and dibutylenetriamine. In one embodiment of the invention, it is useful to utilize polyhydrazides as the polyamine compounds. Representative useful polyhydrazides include oxalic dihydrazide, adipic dihydrazide, succinic dihydrazide, malonic dihydrazide, glutaric dihydrazide, phthalic or terephthalic dihydrazide and itaconic dihydrazide. Additionally, water-soluble hydrazines such as ethylene-1,2-dihydrazide, propylene-1,3-dihydrazide and butylene-1,4-dihydrazide, can also be used as one of the crosslinking agents.

Examples of suitable commercially available latex polymer dispersions of a film-forming binder include the EPS 2720 and EPS 2799 available from Engineered Polymer Solutions of Marengo, IL.

In a preferred embodiment, the invention described herein includes a latex copolymer that is a single stage latex. In an aspect, the single stage latex is formed from monomers that include about 20 to 60, preferably 30 to 55 percent by weight of methyl methacrylate; 0 to 40, preferably 10 to 30 percent by weight of 2-ethyl hexyl acrylate; 10 to 60, preferably 15 to 55 percent by weight of butyl acrylate; about 0 to 30, preferably 10 to 20 percent by weight of butyl methacrylate; and about 0 to 10, preferably 1 to 5 percent by weight of methacrylic acid.

Aqueous compositions of the present disclosure may be latex-based coating compositions. Thus, in some approaches, at least a majority (i.e., more than 50 wt %), more preferably substantially all or all, of the resin solids in the coating compositions are latex polymers. Typically, the coating compositions include at least 20 wt %, at least 30 wt %, at least 40 wt %, or at least 50 wt % of latex polymer solids, based on total solids in the coating composition. Certain high gloss deep base paints may include 80 wt % or more of latex polymer solids. While the upper amount of latex copolymer included in the coating composition may vary widely (e.g., depending upon the amount of pigment included), typically the coating compositions will include less than 90 wt % latex polymer solids, based on total solids.

In certain approaches, the polymeric binders of the present invention may further include one or more bio-based monomers. “Bio-based,” as used with respect to monomers herein, refers to monomers that are preferably obtained from bio-renewable olefinically unsaturated monomers. Such bio-renewable olefinically unsaturated monomers have a carbon-14 (C-14) that is significantly higher than olefinically unsaturated monomers derived from fossil fuels. This is because C-14 has a relatively short half-life on the scale of the age of fossil-fuel-based materials. Thus, “bio-renewable” monomers as used herein mean monomers for which the level of C-14 isotope is comparable to the mean level of C-14 in atmospheric C02, as measured by ASTM D6866 or such monomers having at least about 1.5 dpm/gC (disintegrations per minute per gram carbon), at least 2.5 dpm/gC, or at least 3.0 dpm/gC of C-14, as measured through liquid scintillation counting.

Exemplary bio-based monomers include esters of itaconic acid, bio-derived (meth)acrylic acid, and alkyl (meth)acrylic acid. In embodiments, bio-based monomers make up at least 20 wt %, at least 30 wt %, or at least 40 wt % of the polymeric binder by weight of all monomers interpolymerized to form the polymeric binder.

### Other Additives, Pigments and Fillers

Additional components may be added to the compositions disclosed herein. The components may be added to a polymeric binder composition before, during, or after completion of polymerization, or may be added to another aqueous composition as a post-add. The additional components or additives may be added to either the reaction mixture of monomers used to make a polymeric binder, to an aqueous polymeric binder composition, or to a coating or paint composition that includes or will include the polymeric binder. Suitable additives are known to those of skill in the art and include but are not limited to, for example, surfactants, open time agents, pH adjustors, initiator and chaser solutions, cross-linking agents, preservatives, defoaming agents, anticorrosive agents, thixotropes, rheological modifiers, colorants, and matting agents, and the like. The additives may include one or more ingredients added to a paint or coating to modify the properties or enhance coating performance during storage, handling, application and other or subsequent stages. Desirable performance characteristics of a paint or coating include, for example, chemical resistance, hardness, gloss, reflectivity, appearance and/or a combination of such properties and similar other properties. Preferred performance enhancing additives include lacquers, waxes, flatting agents, additives to prevent mar, abrasion, and the like.

Pigments and fillers may also be added to a coating composition (via a pigment grind) to provide a desired opacity, hiding characteristics, or PVC. Without being bound by theory, it is generally understood that lower PVC coatings show higher gloss and greater scrub durability, because such coatings contain a greater volume proportion of polymeric binder, which generally is believed to provide glossiness and durability to cured coatings.

Pigments may be supplemented with extenders or fillers such as talc, china clay, barytes, carbonates, silicates and mixtures thereof, for example magnesium silicates, calcium carbonate, aluminosilicates, silica and various clays; organic materials including plastic beads (e.g., polystyrene or polyvinyl chloride beads), microspherical materials containing one or more voids, and vesiculated polymer particles (e.g., those discussed in U.S. Pat. Nos. 4,427,835, 4,920,160, 4,594,363, 4,469,825, 4,468,498, 4,880,842, 4,985,064, 5,5157,084, 5,041,464, 5,036,109, 5,409,776, and U.S. Pat. No. 5,510,422). Other exemplary extenders or fillers include EXPANCEL™ 551DE20 acrylonitrile/vinyl chloride expanded particles (from Expancel Inc.), SIL-CEL™ 43 glass micro cellular fillers (from Silbrico Corporation), FILLITE™ 100 ceramic spherical particles (from Trelleborg Fillite Inc.), SPHERICEL™ hollow glass spheres (from Potter Industries Inc.), 3M ceramic microspheres including grades G-200, G-400, G-600, G-800, W-210, W-410, and W-610 (from 3M), 3M hollow microspheres including 3M Performance Additives iM30K (also from 3M), INHANCE™ UH 1900 polyethylene particles (from Fluoro-Seal Inc.), and BIPHOR aluminum phosphate (from Bunge Fertilizantes S.A., Brazil).

In some approaches, aqueous coating compositions of the present disclosure may comprise at least about 5% and up to about 50% by weight pigments based on the total solids present in the composition. In preferred embodiments, pigments may comprise inorganic pigments, such as titanium dioxide. The coating compositions may comprise, for example, about zero percent (for an ultradeep paint), at least about 11% by weight, further for example, at least about 12% by weight, further for example, at least about 13% by weight, further for example, at least about 14% by weight, further for example at least about 15% by weight, further for example, at least about 16%, further for example at least about 17%, further for example, at least about 18%, further for example at least about 19%, and even further for example at least about 20% up to about 30% by weight titanium dioxide. In some approaches, the coating compositions comprise more than 10% titanium dioxide based on the total solids present in the composition. Other colored pigments or dyes may also be added to the coating, alone or in combination, to produce a wide range of colored coating. Suitable additional pigments may include calcium carbonate, talc, clay, silicates, aluminum silicates, calcium metasilicates, aluminum potassium silicates, magnesium silicates, barium sulfates, nepheline syenite, feldspar, zinc oxides or sulfides, or others known to those skilled in the art. Such additional colored pigments may be included in amounts up to about 30% by weight, for example, about 10% to about 20%, based on the total solids present in the composition. In some cases, “pigments” may also refer to functional fillers which are non-water soluble solids. Such functional fillers may include solids which provide additional functional characteristics to the coating, for example, intumescent ingredients, such as ammonium polyphosphates, melamines, pentaerythritol and similar compounds. In one useful embodiment, the coating composition of the present invention is substantially free or totally free of intumescent ingredients such as ammonium polyphosphates, melamines, and pentaerythritol and similar compounds.

Coating compositions of the present disclosure preferably have a PVC of about 5 to about 60.

In an aspect, the compositions described herein may include a coalescing agent that aids in film formation, added to either the reaction mixture of monomers used to make the polymeric binder, to the aqueous polymeric binder composition, or to a coating composition that includes the polymeric binder. Suitable coalescing agents or coalescent compounds are dispersible in a polymeric binder, coating or paint composition that includes the polymeric binder, and facilitate film formation at temperatures of less than about 25° C., and even at temperatures of 5 to 10° C. Preferred coalescing agents are low VOC coalescing agents and have VOC content of less than about 50%, preferably less than about 30%, more preferably, less than about 20%, and most preferably, less than about 15%. Exemplary suitable coalescing agents include low VOC compounds of the type described in detail at least in U.S. Pat. Nos. 6,762,230 and 7,812,079. Other suitable low VOC coalescents include Optifilm (Eastman Chemical, Kingsport TN), Loxanol (Cognis, Kankakee IL, now BASF), Archer RC (ADM, Decator IL), and the like. Conventional coalescing agents such as, Texanol (Eastman Chemical) and the like can also be used, either alone or in combination with other solvents such as, for example, 2-butoxyethanol (butyl cellosolve), diethylene glycol monobutyl ether (butyl carbitol), and the like, provided low VOC levels are maintained in the coating composition or paint.

In an aspect, the compositions described herein may include a UV-VIS absorber. Compounds that are suitable for use in the present disclosure as UV-VIS absorbers include ultraviolet absorbers, visible light absorbers, or combinations thereof. These may also be referred to as photoinitiators.

Suitable UV-VIS absorbers are water-insoluble. By this it is meant that the compounds will not dissolve to an appreciable extent (i.e., will not dissolve in an amount of more than 5 wt %) in water at the temperatures typically used for preparing coatings compositions as described herein.

In certain embodiments, suitable UV-VIS absorbers are those compounds capable of absorbing ultraviolet and/or visible radiation within a range of 240-465 nm. For certain embodiments, they are capable of absorbing radiation in the 280-450 nm range. In certain embodiments, suitable visible light absorbers are those compounds capable of absorbing visible radiation within a range of 420-450 nm. In certain embodiments, suitable ultraviolet absorbers are those compounds capable of absorbing UV radiation within a range of 240-400 nm. For certain embodiments, they are capable of absorbing UV radiation in the 280-400 nm range, and for certain embodiments in the 315-375 nm range.

Examples of suitable ultraviolet absorbers include the following: Benzophenone (available from Lamberti, Gallaratte, Italy); Phenylbis(2,4,6-trimethylbenzoyl)phosphine oxide (available under the trade name IRGACURE 819DW from BASF, Florham Park, N.J.); Ethyl-2,4,6-trimethylbenzoylphenylphosphinate (available under the trade name LUCIRIN TPO-L (formerly: LUCIRIN LR 8893) from BASF, Florham Park, N.J.); 2,4,6-trimethylbenzophenone & 4-methylbenzophenone (available as a mixture under the trade name ESACURE TZT from Lamberti, Gallaratte, Italy); 2,2-Dimethoxy-1,2-diphenylethanone (i.e., Benzildimethylketal) (available under the trade name ESACURE KB 1 from Lamberti); 1-Hydroxycyclohexyl phenyl ketone (i.e., a-hydroxycyclohexylphenylketone) (available under the trade name ESACURE KS 300 from Lamberti); 2-Hydroxy-2-methyl-1-phenyl-1-propanone (available under the trade name ESACURE KL 200 from Lamberti); Polymeric Benzophenone (available under the trade name EBECRYL P39 from Cytec, Woodland Park, N.J.); Isopropylthioxanthone (available under the trade name GENOCURE ITX from Rahn USA, Aurora, IL); Methyl-o-benzoyl-benzoate (available under the trade name GENOCURE MBB from Rahn); Methylbenzoylformate (available under the trade name GENOCURE MBF from Rahn); Benzoin ethyl ether (available from Aldrich. St. Louis, MO); 4′-Ethoxyacetophenone (from Aldrich. St. Louis, MO); and combinations thereof. Other suitable UV-VIS absorbers are available commercially from BASF under the trade designations IRGACURE and LUCERIN. Methyl-o-benzoyl-benzoate is a preferred UV-VIS absorber for, e.g., improving gloss retention and/or dirt pick-up resistance.

The inventive compositions may also include various other additives, including but not limited to thickeners, such as urethane thickeners, and acrylic thickeners in amounts up to about 10% by weight, for example about 1% to about 2%. Synthetic organic materials might also be incorporated; these include plastic beads, hollow spheres or other similar materials. Other optional components include glycols such as ethylene and/or propylene glycol in amounts up to about 7% and other solvents such as diethylene glycol dibenzoate and dipropylene glycol dibenzoate in amounts up to about 3%. The compositions may also contain pigment dispersing agents which can be solvents or surfactants; additional liquid coating preservatives; additional dry film preservatives; foam control agents such as oils, fatty acids and silicones; slip and mar additives; adhesion promoters, and/or other known coating additives. The compositions of the present invention may also comprise further biocides or preservatives including but not limited to metal ion containing compounds, polymeric biocides, quaternary ammonium compounds, heterocyclic compounds, phenols, organometallics, aldehydes, proteins, peroxygens, alcohols, enzymes, polypeptides, and halogen releasing compounds.

### Aqueous Coating Composition

In certain embodiments of the present invention, the nitrogenous, organic additive may be added to a coating composition such as a paint individually or mixed into other components of the coatings composition at varying stages of the coatings composition formation.

In some embodiments, the aqueous composition is a waterborne coating composition. In some embodiments, the aqueous composition is a paint.

In some embodiments, the aqueous composition is a 1K coating composition.

In some embodiments, the aqueous composition is a 2K coating composition.

In some embodiments, the aqueous composition includes at most 300 ppm BIT based on the total components present in the aqueous composition. In further embodiments, the aqueous composition includes at most 150 ppm BIT, in further embodiments, at most 50 PPM BIT. In some embodiments, the coating compositions are substantially free of BIT, essentially free of BIT, or completely free of BIT.

In some embodiments, the aqueous composition includes at most 150 ppm MIT based on the total components present in the composition. In further embodiments, the aqueous composition includes at most 50 ppm MIT, in further embodiments, at most 20 PPM MIT. In some embodiments, the aqueous compositions are substantially free of MIT, essentially free of MIT, or completely free of MIT.

In some embodiments, the aqueous composition include at most 40 ppm of the reaction product of MIT and CMIT based on the total components present in the composition. In further embodiments, the aqueous composition includes at most 25 ppm of the reaction product of MIT and CMIT, in further embodiments, at most 10 PPM of the reaction product of MIT and CMIT. In some embodiments, the aqueous compositions are substantially free of the reaction product of MIT and CMIT, essentially free of the reaction product of MIT and CMIT, or completely free of the reaction product of MIT and CMIT.

In some embodiments, the aqueous compositions includes at most 5000 ppm zinc pyrithione or sodium pyrithione based on the total components present in the composition. In further embodiments, the paint or coatings composition includes at most 3000 ppm zinc pyrithione or sodium pyrithione, in further embodiments, at most 1000 ppm zinc pyrithione or sodium pyrithione, in still further embodiments, at most 50 ppm zinc pyrithione or sodium pyrithione. In some embodiments, the coating compositions are substantially free of zinc pyrithione and sodium pyrithione, essentially free of zinc pyrithione and sodium pyrithione, or completely free of zinc pyrithione and sodium pyrithione.

### Aqueous Polymeric Binder Compositions

In certain embodiments of the present invention, the nitrogenous, organic additive may be added to an aqueous polymeric binder composition individually or mixed into other components of the composition at varying stages of the composition formation. In some useful embodiments, the aqueous polymeric binder is a latex.

In some embodiments, the aqueous polymeric binder composition includes at least 50 ppm of the nitrogenous, organic additive (based on the total weight of polymeric solids). In further embodiments, the aqueous polymeric binder composition includes at least 110 ppm of the nitrogenous, organic additive, in further embodiments at least 140 ppm of the nitrogenous, organic additive, in further embodiments at least 230 ppm of the nitrogenous, organic additive, in further embodiments at least 730 ppm of the nitrogenous, organic additive, in further embodiments at least 2,800 ppm of the nitrogenous, organic additive and in still further embodiments, at least 9,000 ppm of the nitrogenous, organic additive.

In some useful embodiments, the aqueous polymeric binder composition includes at most 300,000 ppm of the nitrogenous, organic additive (based on the total weight of polymeric solids). In further embodiments, the aqueous polymeric binder composition includes at most 230,000 ppm of the nitrogenous, organic additive, in further embodiments at most 150,000 ppm of the nitrogenous, organic additive, in further embodiments at most 80,000 ppm of the nitrogenous, organic additive, in further embodiments at most 50,000 ppm of the nitrogenous, organic additive, and in still further embodiments, at most 20,000 ppm of the nitrogenous, organic additive.

The nitrogenous, organic additives useful in the present invention allow the formulation of aqueous polymeric binder compositions that are adequately preserved or have reduced susceptibility to microbial spoilage and, when added as a component of a coating composition, provide other improved or maintained coating performance characteristics including but not limited to scrub durability, washability, and heat age stability or age stability. In embodiments, said aqueous polymeric binder compositions may be provided without the need for or with a reduced need for the use of conventional biocides like isothiazolinones, pyrithiones, inorganic, or other biocides.

In some useful embodiments, the aqueous polymeric binder compositions include at most 600 ppm BIT (based on the total weight of polymeric solids). In further embodiments, the aqueous polymeric binder composition includes at most 300 ppm BIT, in further embodiments, at most 100 PPM BIT. In some embodiments, the aqueous polymeric binder compositions are substantially free of BIT, essentially free of BIT, or completely free of BIT.

In some useful embodiments, the aqueous polymeric binder compositions include at most 300 ppm MIT (based on the total weight of polymeric solids). In further embodiments, the aqueous polymeric binder composition includes at most 100 ppm MIT, in further embodiments, at most 40 PPM MIT. In some embodiments, the aqueous polymeric binder compositions are substantially free of MIT, essentially free of MIT, or completely free of MIT.

In some useful embodiments, the aqueous polymeric binder compositions include at most 80 ppm of the reaction product of MIT and CMIT (based on the total weight of polymeric solids). In further embodiments, the aqueous polymeric binder composition includes at most 50 ppm of the reaction product of MIT and CMIT, in further embodiments, at most 20 PPM of the reaction product of MIT and CMIT. In some embodiments, the aqueous polymeric binder compositions are substantially free of the reaction product of MIT and CMIT, essentially free of the reaction product of MIT and CMIT, or completely free of the reaction product of MIT and CMIT.

In some useful embodiments, the aqueous polymeric binder compositions include at most 10,000 ppm zinc pyrithione or sodium pyrithione (based on the total weight of polymeric solids). In further embodiments, the aqueous polymeric binder composition includes at most 6,000 ppm zinc pyrithione or sodium pyrithione, in further embodiments, at most 2,000 ppm zinc pyrithione or sodium pyrithione, in still further embodiments, at most 100 ppm zinc pyrithione or sodium pyrithione. In some embodiments, the aqueous polymeric binder compositions are substantially free of zinc pyrithione and sodium pyrithione, essentially free of zinc pyrithione and sodium pyrithione, or completely free of zinc pyrithione and sodium pyrithione.

### Method of Making a Composition and Methods of Making a Coated Article

In certain embodiments of the present invention, a method of making an aqueous composition is provided. In embodiments, a nitrogenous, organic additive is added to a composition at any stage of formation or after formation of the composition in order to form an aqueous coating composition, such as a paint, or an aqueous polymeric binder composition according to any of the embodiments disclosed herein. The nitrogenous, organic additive may be added as a separate component, mixed with other components in the aqueous composition, or added as a mixture with a polymeric binder.

In further embodiments, a method of making a coated article is disclosed, the method comprising the steps of providing a paint or coating composition according to any of the embodiments disclosed herein and coating a substrate with an aqueous coating composition of the present disclosure to form a coated article. Suitable substrates include but are not limited to wood, plastic, drywall, concrete, metal, rubber, or a natural or synthetic polymer. The substrate may be single or multi-layered. The aqueous coating composition of the present disclosure may be applied directly to the substrate or may be applied indirectly to the substrate, such as when the substrate is pre-coated with a primer or an underlayer coating. The aqueous coating composition may be applied by any suitable method, including brush, roller, drawdown, spray, or melt application. Following application, the coating is cured. Curing may occur by drying, including at ambient or elevated temperature, exposure to actinic or ultra-violet radiation, or crosslinking, among other means.

### ILLUSTRATIVE EMBODIMENTS

Embodiment 1. An aqueous composition comprising:
(a) a carrier liquid;
(b) a film-forming polymeric binder; and
(c) at least one nitrogenous, organic additive including a compound comprising four nitrogen centers, each nitrogen center linked to at least one other nitrogen center by at least one saturated divalent hydrocarbon linking group, wherein the nitrogenous, organic additive is a post-addition component of the aqueous composition.
Embodiment 2. The aqueous composition of embodiment 1, wherein the linking groups are each independently a linear or branched C1, C2, C3, or C4 chain.
Embodiment 3. The aqueous composition of any preceding embodiment, wherein the carrier liquid comprises water.
Embodiment 4. The aqueous composition of any preceding embodiment, wherein the aqueous composition is a latex, paint, coating, caulk, or sealant.
Embodiment 5. The aqueous composition of any preceding embodiment, wherein the polymeric binder comprises a multistage latex.
Embodiment 6. The aqueous composition of any preceding embodiment, wherein the polymeric binder comprises a vinyl acrylic latex, a styrene acrylic latex, an all acrylic latex, a polyurethane dispersion (PUD), a waterborne alkyd resin, a waterborne alkyd-PUD hybrid resin, or blends thereof.
Embodiment 7. The aqueous composition of any preceding embodiment, wherein the nitrogenous, organic additive is selected from the group consisting of compounds of Formulas I, II, III, and IV, and mixtures thereof,

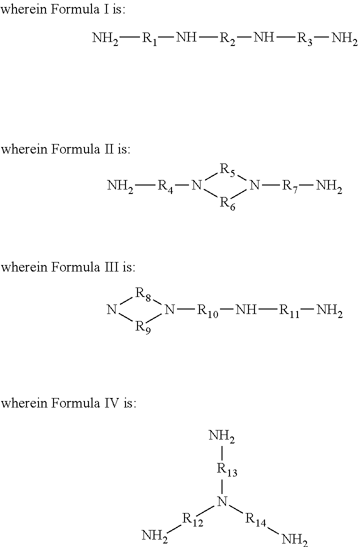

wherein each of R1-R4, R7, and R10-R14 is a saturated hydrocarbon chain having 1 to 3 carbons, each of R5, R6, R8, and R9 is a saturated hydrocarbon chain having 2 to 3 carbons, and each of R1-R14 is the same or different.
Embodiment 8. The aqueous composition of the immediately preceding embodiment, wherein each of R1-R4, R7, and R10-R14 is a saturated hydrocarbon chain having 1 to 2 carbons, each of R5, R6, R8, and R9 is a saturated hydrocarbon chain having 2 to 3 carbons, and each of R1-R14 is the same or different.
Embodiment 9. The aqueous composition of any preceding embodiment, wherein the nitrogenous, organic additive is selected from the group consisting of the compounds: N,N′-bis(2-aminoethyl)-1,2-ethanediamine, N,N′-bis-(2-aminoethyl)piperazine, N[(2-aminoethyl)2-aminoethyl]piperazine, tris-(2-aminoethyl)amine), and mixtures thereof.
Embodiment 10. The aqueous composition of any of embodiments 1 to 6, wherein the nitrogenous, organic additive is selected from the group consisting of the compounds: amino acid hydrazides, hydrazides of carbazido-carboxylic acids, bis-hydrazides and bis-carbazides, diethylene triamine, N,N′-bis(2-aminoethyl)-1,2-ethanediamine, tetraethylene pentamine, pentaethylene hexamine, tris-(2-aminoethyl)amine, N-(2-piperazinoethyl)-ethylene diamine, N,N′-bis-(2-aminoethyl)-piperazine, N,N,N′-tris-(2-aminoethyl)ethylene diamine, N-(2-aminoethyl)-N′-(2-piperazinoethyl-1)-ethylene diamine, N,N-bis-(2-aminoethyl)-N-(2-piperazinoethyl)amine, N,N-bis-(2-piperazinoethyl)-amine, polyethylene imine oligomers comprising at least four functional monomer units, N-(2-aminoethyl)-1,3-propane diamine, polyoxypropylene amine oligomers comprising at least four functional monomer units monomers, tetrapropylene pentamine, tripropylenetetramine, and N,N′-bis-(3-aminopropyl) ethylene diamine, and mixtures thereof.
Embodiment 11. The aqueous composition of any preceding embodiment, wherein the film-forming polymeric binder is substantially free of any functional monomer units comprising reactive ketone moieties that cross-link the film-forming binder during film formation.
Embodiment 12. The aqueous composition of the immediately preceding embodiment, wherein the reactive ketone moieties that cross-link the film-forming binder during film formation comprise diacetone acrylamide (“DAAM”).
Embodiment 13. The aqueous composition of any preceding embodiment, wherein the compounds of the nitrogenous, organic additive are substantially free of any aryl functional groups.
Embodiment 14. The aqueous composition of any preceding embodiment, wherein the aqueous composition comprises at least about 50 ppm by weight of the nitrogenous, organic additive based on the total weight of components of the composition.
Embodiment 15. The aqueous composition of any preceding embodiment, wherein the aqueous composition comprises at most about 100,000 ppm by weight of the nitrogenous, organic additive based on the total weight of components of the composition.
Embodiment 16. The aqueous composition of any preceding embodiment, wherein the aqueous composition comprises at most about 75,000 ppm by weight of the nitrogenous, organic additive based on the total weight of components of the composition.
Embodiment 17. The aqueous composition of any preceding embodiment, wherein the aqueous composition comprises at most about 50,000 ppm by weight of the nitrogenous, organic additive based on the total weight of components of the composition.
Embodiment 18. The aqueous composition of any preceding embodiment, wherein the aqueous composition comprises at least about 75 ppm by weight of the nitrogenous, organic additive based on the total weight of components of the composition.
Embodiment 19. The aqueous composition of any preceding embodiment, wherein the aqueous composition comprises at most about 25,000 ppm by weight of the nitrogenous, organic additive based on the total weight of components of the composition.
Embodiment 20. The aqueous composition of any preceding embodiment, wherein the aqueous composition further comprises no more than about 300 ppm of BIT by weight based on the total weight of components of the composition.
Embodiment 21. The aqueous composition of any of any preceding embodiment, wherein the aqueous composition further comprises no more than about 150 ppm of BIT by weight based on the total weight of components of the composition.
Embodiment 22. The aqueous composition of any preceding embodiment, wherein the aqueous composition comprises no more than about 50 ppm of BIT by weight based on the total weight of components of the composition.
Embodiment 23. The aqueous composition of any preceding embodiment, wherein the aqueous composition further comprises no more than about 150 ppm of MIT by weight based on the total weight of components of the composition.
Embodiment 24. The aqueous composition of any preceding embodiment, wherein the aqueous composition further comprises no more than about 50 ppm of MIT based on the total weight of components of the composition.
Embodiment 25. The aqueous composition of any preceding embodiment, wherein the aqueous composition further comprises no more than about 20 ppm of MIT based on the total weight of components of the composition.
Embodiment 26. The aqueous composition of any preceding embodiment, wherein the aqueous composition is substantially free of MIT based on the total weight of components of the composition.
Embodiment 27. The aqueous composition of any preceding embodiment, wherein the aqueous composition further comprises no more than about 40 ppm of the reaction product of CMIT and MIT based on the total weight of components of the composition.
Embodiment 28. The aqueous composition of any preceding embodiment, wherein the aqueous composition further comprises no more than about 25 ppm of the reaction product of CMIT and MIT based on the total weight of components of the composition.
Embodiment 29. The aqueous composition of any preceding embodiment, wherein the aqueous composition further comprises no more than about 10 ppm of the reaction product of CMIT and MIT based on the total weight of components of the composition.
Embodiment 30. The aqueous composition of any preceding embodiment, wherein the aqueous composition is substantially free of the reaction product of CMIT and MIT based on the total weight of components of the composition.
Embodiment 31. The aqueous composition of any preceding embodiment, wherein the aqueous composition further comprises no more than about 5,000 ppm of zinc pyrithione or sodium pyrithione based on the total weight of components of the composition.
Embodiment 32. The aqueous composition of any preceding embodiment, wherein the aqueous composition further comprises no more than about 3,000 ppm of zinc pyrithione or sodium pyrithione based on the total weight of components of the composition.
Embodiment 33. The aqueous composition of any preceding embodiment, wherein the aqueous composition further comprises no more than about 1,000 ppm of zinc pyrithione or sodium pyrithione based on the total weight of components of the composition.
Embodiment 34. The aqueous composition of any preceding embodiment, wherein the aqueous composition further comprises no more than about 50 ppm of zinc pyrithione or sodium pyrithione based on the total weight of components of the composition.
Embodiment 35. The aqueous composition of any preceding embodiment, wherein the aqueous composition is substantially free of zinc pyrithione and sodium pyrithione.
Embodiment 36. The aqueous composition of any preceding embodiment, wherein when the aqueous composition is a coating or is included in a coating, and the coating is applied to a substrate and cured, the coating displays equivalent or better scrub durability as measured by according to ASTM D2486-96 (Standard Test Method for Scrub Resistance of Wall Paints) and compared to a second coating with the same composition, except that the second coating contains isothiazolone in an equivalent amount to and instead of the nitrogenous, organic additive.
Embodiment 37. The aqueous composition of any preceding embodiment, wherein when the aqueous composition is a coating or is included in a coating, and the coating is applied to a substrate and cured, the coating displays equivalent or better KU viscosity drop over a period of about 3 weeks at about 140° F. and as measured according to ASTM D562-10 (Standard Test Method for Consistency of Paints Measuring Krebs Unit (KU) Viscosity Using a Stormer-Type Viscometer) and compared to a second coating with the same composition, except that the second coating contains isothiazolone in an equivalent amount to and instead of the nitrogenous, organic additive.
Embodiment 38. The aqueous composition of any preceding embodiment, wherein when the aqueous composition is a coating or is included in a coating, and the coating is applied to a substrate and cured, the coating displays equivalent or better washability as measured according to ASTM D4828-94 (2003) “Standard Test Method for Washability of Organic Coatings” and compared to a second coating with the same composition, except that the second coating contains isothiazolone in an equivalent amount to and instead of the nitrogenous, organic additive.
Embodiment 39. The aqueous composition of any preceding embodiment, wherein the aqueous composition is adequately preserved, as defined herein.
Embodiment 40. The aqueous composition of any preceding claim, wherein the aqueous composition develops less than 1×10³ CFU/mL on average when the aqueous composition is subjected to the Microbial Challenge Test.
Embodiment 41. The aqueous composition of any preceding claim, wherein the aqueous composition develops less than 5×10² CFU/mL on average when the aqueous composition is subjected to the Microbial Challenge Test.
Embodiment 42. The aqueous composition of any preceding embodiment, wherein the aqueous composition comprises at least 17% by weight polymeric binder solids.
Embodiment 43. The aqueous composition of any preceding embodiment, wherein aqueous composition is a coating and the coating further comprises a pigment.
Embodiment 44. The coating of embodiment 43, wherein the coating is a 1K, waterborne coating.
Embodiment 45. The coating of any of embodiments 43 or 44, wherein the coating comprises about 10 wt % to about 30 wt % titanium dioxide based on total solids present in the coating.
Embodiment 46. A coating composition comprising:
(a) about 7% to about 30% by weight polymer solids of a film forming polymeric binder;
(b) about 50 ppm to about 50,000 ppm by weight of an nitrogenous, organic additive including at least one compound comprising four nitrogen centers, each nitrogen center linked to at least one other nitrogen center by at least one saturated divalent hydrocarbon linking group, wherein said nitrogenous, organic additive is a post-addition component of the coating composition and is selected from the group consisting of N,N′-bis(2-aminoethyl)-1,2-ethanediamine, N,N′-bis-(2-aminoethyl)piperazine, N[(2-aminoethyl)2-aminoethyl]piperazine, tris-(2-aminoethyl)amine), and mixtures thereof;
(c) at least 10% to about 30% by weight titanium dioxide; and
(d) water.
Embodiment 47: A method of preserving an aqueous composition comprising: adding a nitrogenous, organic additive including at least one compound comprising four nitrogen centers, each nitrogen center linked to at least one other nitrogen center by at least one saturated divalent hydrocarbon linking group to a composition including at least a carrier and a film-forming binder.
Embodiment 48: A coated article comprising: the coating composition of any preceding embodiment coated on a substrate, wherein the substrate comprises wood, plastic, drywall, concrete, metal, rubber or a natural or synthetic polymer.

### EXAMPLES

### Test Methods

The following test methods were used in the evaluation of the control and example paints. Where standard test methods are used to evaluate a property, the standard test methods are provided. Where a property is tested according to a modified version of a standard test method, deviations from the standard test method are described.

### Microbial Challenge Test

Preservative efficacy is tested via microbial challenge test. As conducted herein, microbial challenge test is conducted by subjecting each composition to microbial challenge test in in a manner materially similar to the testing protocol detailed in ASTM D2574-16 Standard Test Method for Resistance of Emulsion Paints in the Container to Attack by Microorganisms (2016). The preservative testing used herein is described below. Discrepancies with ASTM D2574 are included in this description.

Duplicate, 50 mL samples of each of the sample compositions (each sample composition including a different variation of nitrogenous, organic additive and conventional biocide concentration) were taken and each of the duplicate samples inoculated with: (Challenge 1) 5.0 mL of pooled culture at approximately 10⁹ CFU/mL on day 0 resulting in a final concentration of approximately 10⁸ CFU/mL within the sample; (Challenge 2) 2.5 mL of pooled culture at approximately 10⁹ CFU/mL on day 7 resulting in a final concentration of approximately 10⁸ CFU/mL within the sample; and (Challenge 3) 1.25 mL of pooled culture at approximately 10⁹ CFU/mL on day 14 resulting in a final concentration of approximately 10⁸ CFU/mL within the sample. Immediately following inoculation, each sample was then incubated at 30° C.±2° C. For each sample, duplicate spread plates were made at 72 hours incubation and 7 days incubation by spreading 0.1 mL of the sample evenly on a tryptic soy agar plate using aseptic techniques. Each spread plate, so prepared, is then incubated for an additional 72 hours at 30° C.±2° C. and microbial growth observed at that time. Challenge testing was also performed with respect to negative controls, which are agar plates with bacterial challenge, but no paint applied (not to be confused with Negative Control Paint). Negative control spread plate test results are conducted as process verification to check for possible experimental error and are not reported in the below results. Bacterial survival is quantified according to the rating scale shown below in TABLE 1. A total score for the Microbial Challenge Test is determined by averaging the 7-day sample ratings for the third challenge for a given composition. Compositions having a Microbial Challenge Test total score of 6 or less (i.e., developing on average less than 1×10³ CFU/mL—showing “Moderate” contamination) are deemed to pass the Microbial Challenge Test and thus be adequately preserved.

TABLE 1
Preservative Testing Rating Scale

| | | Descriptive | |
|---|---|---|---|
| # Colonies | CFU/mL (approx.) | Rating | Rating |
| No growth | <10¹ | Clean | 1 |
| 1-5 | 1 × 10¹-5 × 10¹ | Slight | 2 |
| 6-10 | 6 × 10¹-1 × 10² | Moderate | 3 |
| 11-25 | 1.1 × 10²-2.5 × 10² | Moderate | 4 |
| 26-50 | 2.6 × 10²-5 × 10² | Moderate | 5 |
| 51-100 | 5.1 × 10²-1 × 10³ | Moderate/ | 6 |
| | | Severe | |
| 101-200 | 1.1 × 10³-2 × 10³ | Severe | 7 |
| 201-300 | 2.1 × 10³-3 × 10³ | Severe | 8 |
| TNTC (rough edges) | 3.1 × 10³-9 × 10⁵ | Severe | 9 |
| TNTC (smooth edges) | 1 × 10⁶ | Severe | 10 |

Wherein “TNTC” = “Too Numerous to Count” and “CFU/mL” = “Colony Forming Unit/milliliter”

### Washability:

Washability is a measure of the relative ease of removing common soils and stains from a coated surface by manual or mechanical washing. Washability is assessed according to ASTM D4828-94, with at least crayon, black ink pen, pencil, and red lipstick used as stains, and 10 mL Formula 409 as a liquid cleanser with evaluation after 50 cycles.

### Scrub Durability:

Scrubs is a measure of the relative ability of a coating to resist erosion, or removal of coating from the substrate, from scrubbing. Scrubs is measured via ASTM D2486-17, test method AorB.

### Age Stability and Heat Age Stability of Dispersion:

“Heat age stability” or “heat age stable” as generally used with reference to compositions herein refers to a composition that exhibits less than a 10 unit KU viscosity increase after about 3 weeks of aging at about 140° F. “Age stability” or “age stable” as generally used with reference to compositions herein refers to a composition that exhibits less than a 5 to 10 unit KU viscosity increase after about 3 weeks of aging at room temperature (approximately 68° F.). Viscosity is measured in KU or Krebs Units in accordance with ASTM D562-10 (Standard Test Method for Consistency of Paints Measuring Krebs Unit (KU) Viscosity Using a Stormer-Type Viscometer) and ICI units in accordance with ASTM D4287-00 (Standard Test Method for High-Shear Viscosity Using a Cone/Plate Viscometer).

### Example 1

A positive control, vinyl acrylic, base paint (“Positive Control Paint”), ProMar™ 200 Zero VOC-Interior Latex Gloss Sheen, Extra White, available from The Sherwin-Williams Company, Cleveland, Ohio, which contains post-add preservatives consisting of 800 ppm Proxel® BD-20 an aqueous dispersion containing 19.3 wt. % 1,2-benzisothiazolin-3-one; available from Arxada Corp.) and 300 ppm Zinc Omadine® ZOE (emulsion containing 48 wt. % zinc 2-pyridinethiol-1-oxide emulsion; available from Arxada Corp.) was obtained. A negative control paint (“Negative Control Paint”), was prepared by conventional paint making methods using the same formula but omitting post-add preservatives (800 ppm Proxel® BD-20 and 300 ppm Zinc Omadine® emulsion). The control paints were compared to several example paints consisting of ProMar™ 200 Zero VOC-Interior Latex Gloss Sheen, Extra White (vinyl acrylic) with alternative post-add preservatives as shown in Table 2. The paint was prepared by mixing conventional components using techniques known to those of ordinary skill in the art.

TABLE 2
Control and Example Base Paint Preservatives in ppm¹

| | | Zinc Omadine ® | |
|---|---|---|---|
| Sample | Proxel BD-20 | ZOE emulsion | TETA² |
| Positive Control | 800 | 300 | — |
| Paint | | | |
| Negative Control | — | — | — |
| Paint | | | |
| Example Paint 1 | 800 | 300 | 750 |
| Example Paint 2 | 800 | 300 | 500 |
| Example Paint 3 | 800 | 300 | 250 |
| Example Paint 4 | — | — | 750 |

Preservative Efficacy Testing for the Positive Control Paint, Negative Control Paint, and Example Paints 1-4 are shown below in TABLE 3.

TABLE 3
Preservative Efficacy Testing Results

| | Challenge | | | | | | | | | | | |
|---|---|---|---|---|---|---|---|---|---|---|---|---|
| | Challenge 1 | | | | Challenge 2 | | | | Challenge 3 | | | |
| | Time from Sample Application | | | | | | | | | | | |
| | 72 | 72 | 7 | 7 | 72 | 72 | 7 | 7 | 72 | 72 | 7 | 7 |
| | Hrs | Hrs | Days | Days | Hrs | Hrs | Days | Days | Hrs | Hrs | Days | Days |
| | Streak Plate | | | | | | | | | | | |
| Sample | A | B | A | B | A | B | A | B | A | B | A | B |
| Positive | 1 | 5 | 7 | 9 | 2 | 1 | 2 | 1 | 1 | 1 | 2 | 1 |
| Control | | | | | | | | | | | | |
| Paint | | | | | | | | | | | | |
| Negative | 2 | 3 | 2 | 3 | 10 | 10 | 10 | 10 | 10 | 10 | 10 | 10 |
| Control | | | | | | | | | | | | |
| Paint | | | | | | | | | | | | |
| Example | 1 | 1 | 1 | 1 | 1 | 1 | 1 | 1 | 1 | 1 | 1 | 1 |
| Paint 1 | | | | | | | | | | | | |
| Example | 1 | 1 | 1 | 1 | 1 | 1 | 1 | 1 | 1 | 1 | 1 | 1 |
| Paint 2 | | | | | | | | | | | | |
| Example | 1 | 1 | 1 | 1 | 1 | 1 | 1 | 1 | 1 | 1 | 1 | 2 |
| Paint 3 | | | | | | | | | | | | |
| Example | 2 | 2 | 2 | 2 | 2 | 2 | 2 | 2 | 8 | 8 | 2 | 1 |
| Paint 4 | | | | | | | | | | | | |

Example Paint 4 yields a Microbial Challenge Test total score of (2+1)/2=1.5. Therefore, Example Paint 4 shows bacterial contamination of less than 5×10¹ CFU/mL on average when subjected to Microbial Challenge Test.

Washability test results for the Positive Control Paint and Example Paint 4 are shown below in TABLE 4.

TABLE 4
Washability Test Results

| | Washability Results | | | | | | | | | | |
|---|---|---|---|---|---|---|---|---|---|---|---|
| | | Red | | | | | | | | | |
| Paint | Tea | Wine | Ketchup | Mustard | Grape | Coffee | Crayon | Lipstick | Pencil | Pen | Total |
| Positive | 3 | 3 | 3 | 3 | 3 | 3 | 10 | 10 | 7 | 7 | 52 |
| Control | | | | | | | | | | | |
| Paint | | | | | | | | | | | |
| Example | 3 | 3 | 7 | 3 | 3 | 3 | 10 | 7 | 7 | 3 | 52 |
| Paint 4 | | | | | | | | | | | |

Scrub durability test results (ASTM D2486-17, Test Method B) for the Positive Control Paint and Example Paint 4 are shown below in TABLE 5. A “Standard Paint” is employed to allow normalizing of results in accordance with ASTM D2486-17.

TABLE 5
Scrub Durability Test Results

| | Standard First Break | | | | Paint First Break | | | |
|---|---|---|---|---|---|---|---|---|
| | Sample | Sample | | | Sample | Sample | | % |
| | A | B | Average | | A | B | Average | Paint/Standard |
| Standard | 568 | 575 | 571.5 | Positive | 891 | 909 | 900 | 157 |
| Paint | | | | Control | | | | |
| | | | | Paint | | | | |
| Standard | 565 | 504 | 534.5 | Example | 1011 | 824 | 917.5 | 172 |
| Paint | | | | Paint 4 | | | | |

Age stability test results for the Positive Control Paint and Example Paint 4 and heat age stability test results for the Example Paint 4 are shown below in TABLE 6.

TABLE 6
Age and Heat Age Stability Test Results

| | | Time | | | | | | |
|---|---|---|---|---|---|---|---|---|
| | | Initial | Week 1 | | Week 2 | | Week 4 | |
| | | Temp. | | | | | | |
| | | Room | Room | | Room | | Room | |
| Paint | Viscosity | Temp | Temp | 140° F. | Temp | 140° F. | Temp | 140° F. |
| Positive | KU Mid | 111 | 111 | N/A | 112 | N/A | 117 | N/A |
| Control | Shear | | | | | | | |
| Paint | ICI High | 1.334 | 1.359 | N/A | 1.395 | N/A | 1.538 | N/A |
| | Shear | | | | | | | |
| Example | KU Mid | 107 | 109 | 115 | 111 | 118 | 112 | 117 |
| Paint 1 | Shear | | | | | | | |
| | ICI High | 1.310 | 1.332 | 1.574 | 1.407 | 1.649 | 1.420 | 1.632 |
| | Shear | | | | | | | |

What is claimed is:

1-50. (canceled)

51. A waterborne architectural coating composition comprising:
(a) about 7% to about 30% by weight polymer solids of one or more of a film forming polymeric binders selected from the group consisting of acrylic, vinyl acrylic, styrene acrylic, waterborne polyurethane dispersions (PUD), waterborne alkyd binder resins, and waterborne alkyd-PUD hybrid resins;
(b) about 50 ppm to about 50000 ppm by weight of a nitrogenous, organic preservative including at least one compound comprising four nitrogen centers, each nitrogen center linked to at least one other nitrogen center by at least one saturated divalent hydrocarbon linking group, wherein said nitrogenous, organic additive is a post-addition component of the coating composition and is selected from the group consisting of compounds: N,N′-bis(2-aminoethyl)-1,2-ethanediamine, N,N′-bis-(2-aminoethyl)piperazine, N[(2-aminoethyl)2-aminoethyl]piperazine, tris-(2-aminoethyl)amine), and mixtures thereof;
(c) at least 10% to about 30% by weight titanium dioxide; and
(d) water.

52. The waterborne architectural coating composition of claim 51,
wherein the coating composition is substantially free of crosslinking monomers preferably including reactive ketone moieties.

53. The waterborne architectural coating composition of claim 51,
wherein the coating composition is substantially free of conventional biocides and preservatives.

54. The waterborne architectural coating composition of claim 51,
wherein the coating composition is substantially free of BIT.

55. The waterborne architectural coating composition of claim 51,
wherein the coating composition includes BIT in an amount of no more than 300 ppm BIT.

56. The waterborne architectural coating composition of claim 51,
wherein the coating composition is substantially free of MIT.

57. The waterborne architectural coating composition of claim 51,
wherein the coating composition includes MIT in an amount of no more than 150 ppm MIT.

58. The waterborne architectural coating composition of claim 51,
wherein the coating composition is substantially free of the reaction product of CMIT and MIT.

59. The waterborne architectural coating composition of claim 51,
wherein the coating composition includes the reaction product of CMIT and MIT in an amount of no more than about 40 ppm.

60. The waterborne architectural coating composition of claim 51,
wherein the coating composition is substantially free of sodium pyrithione and zinc pyrithione.

61. The waterborne architectural coating composition of claim 51,
wherein the coating composition includes zinc pyrithione or sodium pyrithione in an amount of no more than about 5000 ppm.

62. The waterborne architectural coating composition of claim 51, wherein when the coating composition is a coating or is included in a coating, and the coating is applied to a substrate and cured, the coating displays equivalent or better scrub durability as measured by according to ASTM D2486-96 (Standard Test Method for Scrub Resistance of Wall Paints) and compared to a second coating with the same composition, except that the second coating contains isothiazolone in an equivalent amount to and instead of the nitrogenous, organic additive.

63. The waterborne architectural coating composition of claim 51, wherein when the coating composition is applied to a substrate and cured, the coating displays equivalent or better KU viscosity drop over a period of about 3 weeks at about 140° F. and as measured according to ASTM D562-10 (Standard Test Method for Consistency of Paints Measuring Krebs Unit (KU) Viscosity Using a Stormer-Type Viscometer) and compared to a second coating with the same composition, except that the second coating contains isothiazolone in an equivalent amount to and instead of the nitrogenous, organic additive.

64. The waterborne architectural coating composition of claim 51, wherein when the aqueous composition is a coating or is included in a coating, and the coating is applied to a substrate and cured, the coating displays equivalent or better washability as measured according to ASTM D4828-94 (2003) “Standard Test Method for Washability of Organic Coatings” and compared to a second coating with the same composition, except that the second coating contains isothiazolone in an equivalent amount to and instead of the nitrogenous, organic additive.

65. The waterborne architectural coating composition of claim 51, wherein the coating composition develops less than 1×10³ CFU/mL and/or 1×10³ CFU/mL on average when the aqueous composition is subjected to the Microbial Challenge Test as defined herein.
